(19) United States
(12) Patent Application Publication
(10) Pub. No.: US 2026/0323683 A1
(43) Pub. Date: Oct. 15, 2026

(54) Wireless Device, Network Node, and Methods Performed Thereby, For Handling Information

(71) Applicant: Telefonaktiebolaget LM Ericsson (PUBL), Stockholm (SE)

(72) Inventors: Bikramjit SINGH, RAASEPORI (FI); Du Ho KANG, SOLLENTUNA (SE); Jonas FRÖBERG OLSSON, LJUNGSBRO (SE); Jose Luis PRADAS, STOCKHOLM (SE)

(21) Appl. No.: 19/486,067

(22) PCT Filed: May 29, 2024
(86) PCT No.: PCT/SE2024/050530

§ 371 Date: Nov. 20, 2025

Related U.S. Application Data
(60) Provisional application No. 63/505,127, filed on May 31, 2023.

(51) Int. Cl. H04W 72/566; H04W 28/02

(52) U.S. Cl. CPC H04W 72/569; H04W 28/0236

(57) ABSTRACT

A method, performed by a wireless device (130), for handling information. The wireless device (130) operates in a wireless communications network (100). The wireless device (130) sends (303) information to a network node (110) operating in the wireless communications network (100). The sending (303) of the information is with a first priority. The first priority is a) based on a delay in the transmission of the information, and b) independent of a second priority assigned to an identity of a logical channel used for the sending (303) of the information and a group of the logical channel.

### TECHNICAL FIELD

The present disclosure relates generally to a wireless device and methods performed thereby for handling information. The present disclosure further relates generally to a network node and methods performed thereby, for handling the information.

### BACKGROUND

Wireless devices within a wireless communications network may be e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc. . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network (CN), which may be referred to as Next Generation (NG) Core Network, abbreviated as NG-CN, NGC, 5G CN or 5G Core (5GC). NG may be understood to refer to the interface/reference point between the Radio Access Network (RAN) and the CN in 5G/NR. In a 5G System (5GS), a radio base station in NR may be referred to as a gNB or 5G Node B. An NR UE may be referred to as an nUE.

### XR

In the ongoing Rel-18 study item on extended Reality (XR), several enhancements are being proposed to increase XR capacity of 5G-Advanced systems.

eXtended Reality (XR)

XR may include services provided by computer technologies and wearables that may allow for human-machine interaction in real/virtual mixed environments. XR may include Virtual Reality (VR), Augmented Reality (AR), Mixed Reality (MR), Cloud Gaming, and the areas interpolated among them. As such, XR may usually be considered a mixed enhanced Mobile Broadband (eMBB)/Ultra Reliable and Low Latency Communications (URLLC) service; as reported in Table 1, XR traffic may be a mixture of heterogeneous UL/DL data flows, including video, audio, and control traffic.

TABLE 1
XR traffic characteristics and requirements identified by 3GPP.

| | | Data rate | Packet (frame) | Packet Delay |
|---|---|---|---|---|
| | | [Mbps] | rate [fps] | Budget (PDB) [ms] |
| DL | AR/VR Video | 30 | 60 | 10 |
| | Cloud Gaming | 30 | 60 | 15 |
| UL | Pose/control | 0.2 | 250 | 10 |
| | Video (Scene) | 10 | 60 | 30 |

Table 1 highlights that XR traffic flows may have different characteristics, e.g., packet rate in frame per second [fps] and bit rate in bit per second [bps]) and requirements in terms of, e.g., application, packet delay budget (PDB) [ms]. Among XR flows, DL video and UL scene traffic may be periodic, with possible jitter particularly in DL, and may have variable large-sized application packets.

### LCH/LCG Priority

Multiple logical channels of different priorities may be multiplexed into the same transport block using the Medium Access Control (MAC) multiplexing functionality. Except for the case when the uplink scheduling grant may provide resources sufficient to transmit all data on all logical channels, the multiplexing may need to prioritize between the logical channels. However, unlike the downlink case, where the prioritization may be understood to be up to the scheduler implementation, the uplink multiplexing may be done according to a set of well-defined rules in the device with parameters that may be set by the network. The reason for this may be understood to be that a scheduling grant may apply to a specific uplink carrier of a device, not explicitly to a specific logical channel within the carrier.

A simple approach may be to serve the logical channels in strict priority order. However, this may result in starvation of lower priority channels. That is, all resources may go to the high-priority channel until the buffer is empty. Typically, an operator may instead like to provide at least some throughput for low-priority services as well. Furthermore, as NR may be understood to be designed to handle a mixture of a wide range of traffic types, a more elaborate scheme may be needed. For example, traffic due to a file upload may not necessarily exploit a grant intended for a latency-critical service, that is, if a grant is received for a latency service, its usage for a non-latency service may need to be avoided.

The starvation problem is present already in LTE, where it may be handled by assigning a guaranteed data rate to each channel. The logical channels may be then served in decreasing priority order up to their guaranteed data rate, which may avoid starvation as long as the scheduled data rate is at least as large as the sum of the guaranteed data rates. Beyond the guaranteed data rates, channels may be served in strict priority order until the grant may be fully exploited, or the buffer may be empty.

NR may apply a similar approach. However, given the large flexibility of NR in terms of different transmission durations and a wider range of traffic types supported, a more advanced scheme may be needed. One possibility may be to define different profiles, each outlining an allowed combination of logical channels, and explicitly signal the profile to use in the grant. However, in NR, the profile to use may be implicitly derived from other information available in the grant rather than explicitly signaled.

Upon reception of an uplink grant, two steps may be performed. First, the device may determine which logical channels may be eligible for multiplexing using this grant. Second, the device may determine the fraction of the resources that may have to be given to each of the logical channels.

The first step may determine the logical channels from which data may be transmitted with the given grant. This may be seen as an implicitly derived profile. For each logical channel, the device may be configured with: the set of allowed subcarrier spacings this logical channel may be allowed to use, the maximum Physical Uplink Shared Channel (PUSCH) duration which may be possible to schedule for this logical channel, and the set of serving cells, that is, the set of uplink component carriers the logical channel may be allowed to be transmitted upon.

Only the logical channels for which the scheduling grant may meet the restrictions configured may be allowed to be transmitted using this grant, that is, may be eligible for multiplexing at this particular time instant. In addition, the logical channel multiplexing may also be restricted for transmission without a dynamic grant. That is, restrictions may be applied for a configured grant, that is periodic or semi-persistent grant, as well, not just a dynamic grant alone.

Coupling the multiplexing rule to the PUSCH duration may be understood to be in 3GPP motivated by the possibility to control whether latency-critical data may be allowed to exploit a grant intended for less time-critical data.

As an example, assume there are two data flows, each on a different logical channel. One logical channel carries latency-critical data and is given a high priority, while the other logical channel carries non-latency-critical data and is given a low priority. The gNB may take scheduling decisions based on, among other aspects, information about the buffer status in the device provided by the device. Assume that the gNB scheduled a relatively long PUSCH duration based on information that there is only non-time-critical information in the buffers. During the reception of the scheduling grant, time-critical information arrives to the device. Without the restriction on the maximum PUSCH duration, the device would transmit the latency critical data, possibly multiplexed with other data, over a relatively long transmission duration and potentially not meeting the latency requirements set up for the particular service. Instead, a better approach may be to separately request a transmission during a short PUSCH duration for the latency critical data, something which may be possible by configuring the maximum PUSCH duration appropriately. Since the logical channel carrying the latency-critical traffic may have been configured with a higher priority than the channel carrying the non-latency-critical service, the noncritical service may not block transmission of the latency-critical data during the short PUSCH duration.

The reason to also include the subcarrier spacing may be understood to be similar to the duration. In the case of multiple subcarrier spacings configured for a single device, a lower subcarrier spacing may imply a longer slot duration and the reasoning above may also be applied in this case.

Restricting the uplink carriers allowed for a certain logical channel may be motivated by the possibly different propagation conditions for different carriers and by dual connectivity. Two uplink carriers at vastly different carrier frequencies may have different reliability. Data which are critical to receive may be better to transmit on a lower carrier frequency to ensure good coverage, while less-sensitive data may be transmitted on a carrier with a higher carrier frequency and possibly spottier coverage. Another motivation may be duplication, that is, the same data transmitted on multiple logical channels, to obtain diversity. If both logical channels would be transmitted on the same uplink carrier, the original motivation for duplication—to obtain a diversity effect—would be gone.

The set of logical channels from which data may be allowed to be transmitted given the current grant may be established, based on the mapping-related parameters configured. Multiplexing of the different logical channels may also need to answer the question of how to distribute resources between the logical channels having data to transmit and eligible for transmission. This may be done based on a set of priority-related parameters configured for each local channel: priority, prioritized bit rate (PBR), and bucket size duration (BSD). The prioritized bit rate and the bucket size duration together may serve a similar purpose as the guaranteed bit rate in LTE but may account for the different transmission durations possible in NR. The product of the prioritized bit rate and the bucket size duration may be in essence a bucket of bits that at a minimum may be transmitted for the given logical channel during a certain time. At each transmission instant, the logical channels may be served in decreasing priority order, while trying to fulfil the requirement on the minimum number of bits to transmit. Excess capacity when all the logical channels are served up to the bucket size may be distributed in strict priority order.

An example of priority handling and logical channel multiplexing according to existing methods is illustrated FIG. 1. FIG. 1 depicts an example of logical channel prioritization for four different scheduled data rates and two different PUSCH durations. Panel a) of FIG. 1 depicts the four different channels to be multiplexed, in decreasing priority order from left to right. For each one of the channels, the horizontal axis depicts the maximum PUSCH duration allowed as 0.25 ms, 0.25 ms, 0.5 ms and 0.5 ms, respectively, while the vertical axis depicts the buffer level. For each logical channel, the buffer level underneath the dashed horizontal crossline corresponds to the prioritized bit rate. Panel b) of FIG. 1 depicts the result after logical-channel multiplexing for different combinations of granted rate and scheduled PUSCH duration. Particularly, the graph on the left side of panel b) depicts the result after logical-channel multiplexing for different combinations of granted rate and PUSCH duration of 0.25 ms scheduled, whereas the graph on the right of panel b) depicts the result after logical-channel multiplexing for different combinations of granted rate and PUSCH duration of 0.5 ms scheduled. The horizontal dashed lines on panel b) denote the different levels of granted rate. It may be appreciated that in the left hand side graph on panel b), for each level of granted rate, the PUSCH is filled first up to the PBR for each logical channel, in order of decreasing priority. If there are additional resources in the granted rate once the PBR or each of the logical channels has been fulfilled, the additional resources are filled next with data remaining in the buffer level of each logical channel, in decreasing priority order. As illustrated in FIG. 1, if there are more resources or less, the resources may be served with beyond Guaranteed Bit Rate (GBR), or lesser than that. In the depicted case, the additional resources in the largest granted rate for the PUSCH duration of 0.25 ms scheduled is filled with data from the first logical channel in panel a). That is, the solid black LCID on the first bar on the left hand side graph of panel b) gets the opportunity to fill resource twice as per PBR. In other LCID, the bit rate is pushed lesser than assigned PBR. The fourth bar on the left hand side graph of panel b), having the shortest granted rate, is filled up to GBR of the solid black LCID only, that is, the highest priority channel depicted in panel a). In the right hand side graph on panel b), for each level of granted rate, the PUSCH is filled with the remaining data from the logical channels, in strict order of decreasing priority.

More details on this section may be found in [1].

### SUMMARY

As part of the development of embodiments herein, one or more challenges with the existing technology will first be identified and discussed.

In the current logical channel prioritization procedure, the UE may be understood to always select the highest priority channels which are typically associated to the highest priority data. In other words, each Data Radio Bearer (DRB) may be associated to a priority level. This may lead to that data with lower priority is scheduled less often or in smaller amounts.

The issue appears when the priority of data may not be always defined a priori but it may depend on the time budget relatively to other data. Time budget may be understood to refer to a delay left, which may be understood to mean a remaining time until a time deadline, e.g., time deadline-packet arrival time. Priority of the data may increase as the packet delay budget is being consumed and thus, data which may have had a priori a low priority because of the long PDB, may become of high priority if it is not served for a long time and may be served before other data which may have a larger packet delay budget left.

Certain aspects of the present disclosure and their embodiments may provide solutions to these or other challenges.

According to the foregoing, it is an object of embodiments herein to improve the handling of information.

According to a first aspect of embodiments herein, the object is achieved by a method, performed by a wireless device. The method is handling information. The wireless device operates in a wireless communications network. The wireless device sends information to a network node operating in the wireless communications network. The sending of the information is with a first priority. The first priority is a) based on a delay in the transmission of the information, and b) independent of a second priority assigned to an identity of a logical channel used for the sending of the information and a group of the logical channel.

According to a second aspect of embodiments herein, the object is achieved by a method, performed by the network node. The method is for handling the information. The network node operates in the wireless communications network. The network node receives the information from the wireless device operating in the wireless communications network. The receiving of the information is with the first priority. The first priority is a) based on the delay in the transmission of the information, and b) independent of the second priority assigned to the identity of the logical channel used for the receiving of the information and the group of the logical channel.

According to a third aspect of embodiments herein, the object is achieved by the wireless device, configured to perform the method. The wireless device may be understood to be for handling the information. The wireless device is configured to operate in the wireless communications network. The wireless device is configured to send information to the network node configured to operate in the wireless communications network. The sending of the information is configured to be with the first priority. The first priority is configured to be a) based on the delay in the transmission of the information, and b) independent of the second priority configured to be assigned to the identity of the logical channel configured to be used for the sending of the information and the group of the logical channel.

According to a fourth aspect of embodiments herein, the object is achieved by the network node, configured to perform the method. The network node may be understood to be for handling the information. The network node is configured to operate in the wireless communications network. The network node is configured to receive the information from the wireless device configured to operate in the wireless communications network. The receiving of the information is configured to be with the first priority. The first priority is configured to be a) based on the delay in the transmission of the information, and b) independent of the second priority configured to be assigned to the identity of the logical channel configured to be used for the receiving of the information and the group of the logical channel.

By the wireless device sending the information with the first priority based on the delay in the transmission of the information, the wireless device may support enhanced UL delay-aware scheduling with dynamic logical channel prioritization. Embodiments herein, may be understood to reduce error rate for low priority data, which may otherwise not get a chance to be transmitted due to presence of high priority data present alongside. To increase capacity, UL scheduling may be improved to make better use of the delay information and more flexibly assign priorities to traffic.

In, for example, XR applications, it is well expected to have multiple traffic flows, e.g., multiple video streams, audio, pose, etc., in addition to legacy Mobile BroadBand (MBB) traffic. Therefore, embodiments herein may further enhance delay-based prioritization when multiple traffic flows may be present. This may include the new signalling for dynamic prioritization and changes of existing LCP accordingly.

### BRIEF DESCRIPTION OF THE DRAWINGS

Examples of embodiments herein are described in more detail with reference to the accompanying drawings, according to the following description.

FIG. 1 is a schematic diagram depicting an example of logical channel prioritization, according to existing methods.

FIG. 2 is a schematic diagram depicting an example of a wireless communications network, according to embodiments herein.

FIG. 3 is a flowchart depicting a method in a wireless device, according to embodiments herein.

FIG. 4 is a flowchart depicting a method in a network node, according to embodiments herein.

FIG. 5 is a schematic diagram depicting an example of aspects of a method according to embodiments herein.

FIG. 6 is a schematic diagram depicting of aspects of a method prioritizing packets.

FIG. 7 is a schematic block diagram illustrating an embodiment of a wireless device, according to embodiments herein.

FIG. 8 is a schematic block diagram illustrating an embodiment of a network node, according to embodiments herein.

FIG. 9 is a flowchart depicting a method in a wireless device, according to examples related to embodiments herein.

FIG. 10 is a flowchart depicting a method in a network node, according to examples related to embodiments herein.

FIG. 11 is a schematic block diagram illustrating an example of a communication system 1100 in accordance with some embodiments.

FIG. 12 is a schematic block diagram illustrating an example of a UE 1200 in accordance with some embodiments.

FIG. 13 is a schematic block diagram illustrating an example of a network node 1300 in accordance with some embodiments.

FIG. 14 is a schematic block diagram illustrating a host 1400, which may be an embodiment of the host 1116 of FIG. 11, in accordance with various aspects described herein.

FIG. 15 is a schematic block diagram illustrating an example of a virtualization environment 1500 in which functions implemented by some embodiments may be virtualized.

FIG. 16 shows a communication diagram of a host 1602 communicating via a network node 1604 with a UE 1606 over a partially wireless connection in accordance with some embodiments.

### DETAILED DESCRIPTION

Certain aspects of the present disclosure and their embodiments may provide solutions to the challenges discussed in the Background and Summary sections or other challenges. Embodiments herein may be generally understood to relate to a prioritization of delayed data. Particular embodiments may relate to a prioritization of delayed low-priority Logical Channel Identity (LCID) data. Particularly, embodiments herein may relate to an approach where a network may configure grants or the number of grants to which a UE may have to apply an indicated delay bucket index to be prioritized. In Rel-18, it was agreed to have delay information reported to a network. According to this, a UE may report a delay status to the network with different indexes corresponding to different data amounts, and the network may indicate back an index. When a UE may receive the indicated delay bucket index, based on remaining PDB or left PDB, it may prioritize data belonging to the indicated delay bucket index. This may mean that if a UE is configured with resources with certain LCID, then construction of MAC Protocol Data Unit (PDU), of the Transport Block (TB), to be transmitted on those resources may select data with relatively lower Logical Channel (LCH)/Logical Channel Group (LCG) priority provided that the data may be delayed, e.g., queuing time in buffer may be over some threshold delay time limit.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

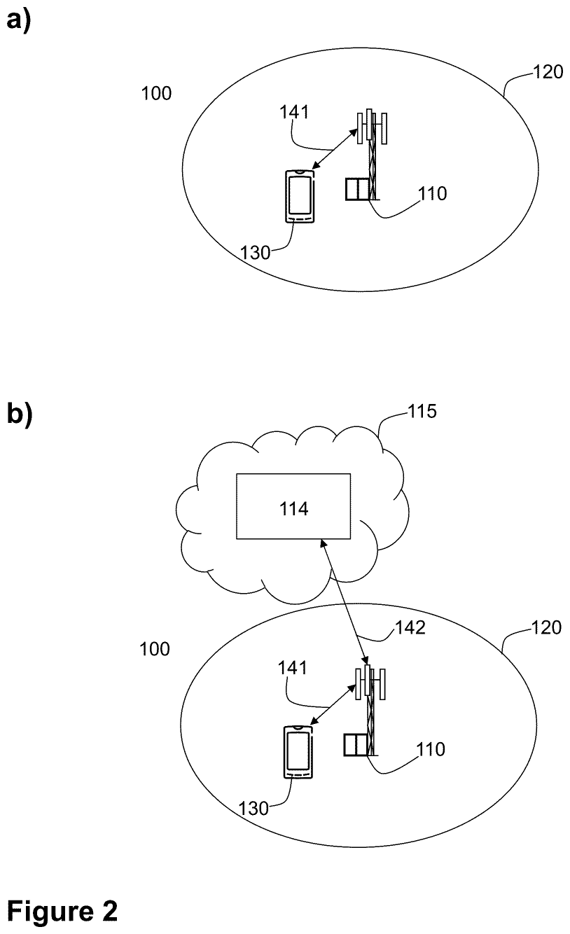

FIG. 2 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System. In other examples, the wireless communications network 100 may be a newer system with similar functionality. The wireless communications network 100 may support XR. In other examples, the wireless communications network 100 may, e.g., in addition, support other technologies such as, for example, Long-Term Evolution (LTE), e.g., LTE for machines (LTE-M), LTE Frequency Division Duplex (FDD), LTE Time Division Duplex (TDD), LTE Half-Duplex Frequency Division Duplex (HD-FDD), LTE operating in an unlicensed band, such as LTE Licensed-Assisted Access (LAA), enhanced eLAA (eLAA), further enhanced LAA (feLAA) and/or MulteFire. Yet in other examples, the wireless communications network 100 may further support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. The wireless communications network 100 may support Machine Type Communication (MTC), enhanced MTC (eMTC), Internet of Things (IOT) and/or NarrowBand IoT (NB-IOT). Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of network nodes, whereof a network node 110 is depicted in the non-limiting example of FIG. 2. The network node 110 may be a radio network node. That is, a transmission point such as a radio base station, for example a gNB, or any other network node with similar features capable of serving a user equipment, such as a wireless device or a machine type communication device, in the wireless communications network 100. In some examples, such as that depicted in FIG. 2 b, the network node 110 may be a distributed node, and may partially perform its functions in collaboration with a virtual node 114 in a cloud 115. The network node 110 may be directly connected to one or more core networks, e.g., to one or more network nodes in the one or more core networks.

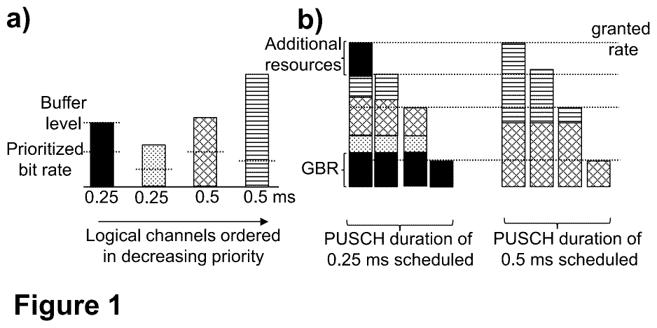

The wireless communications network 100 may cover a geographical area, which in some embodiments may be divided into cell areas, wherein each cell area may be served by a radio network node, although, one radio network node may serve one or several cells. In the example of FIG. 1, the network node 110 serves a cell 120. The network node 110 may be of different classes, such as, e.g., macro base station, home base station or pico base station, based on transmission power and thereby also cell size. In some examples, the network node 110 may serve receiving nodes with serving beams. The network node 100 may support one or several communication technologies, and its name may depend on the technology and terminology used.

A plurality of wireless devices may be located in the wireless communication network 100, whereof a wireless device 130, is depicted in the non-limiting example of FIG. 2. The wireless device 130 comprised in the wireless communications network 100 may be a wireless communication device such as a User Equipment (UE), e.g., 5G UE or nUE, which may also be known as e.g., mobile terminal, wireless terminal and/or mobile station, a mobile telephone, cellular telephone, or laptop with wireless capability, just to mention some further examples. The wireless device 130 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, goggles, a sensor, IoT device, NB-IOT device, device equipped with a wireless interface, such as a printer or a file storage device, modem, or any other radio network unit capable of communicating over a radio link in a communications system. The wireless device 130 comprised in the wireless communications network 100 may be enabled to communicate wirelessly in the wireless communications network 100. The communication may be performed e.g., via a RAN, and possibly the one or more core networks, which may be comprised within the wireless communications network 100. The wireless device 130 may support XR.

The wireless device 130 may be configured to communicate within the wireless communications network 100 with the network node 110 over a first link 141, e.g., a radio link. The network node 110 may be configured to communicate within the wireless communications network 100 with the virtual network node 114 over a second link 142, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first” and/or “second” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 130, e.g., a 5G UE, nUE or a UE, and embodiments related to a network node, such as the network node 110, e.g., a gNB.

Some embodiments herein will now be further described with some non-limiting examples, which may be combined with the embodiments described.

In the following description, any reference to a/the UE, or simply “UE” may be understood to equally refer the wireless device 130; any reference to a/the gNB and/or a/the network may be understood to equally refer to the network node 110; any reference to a/the “cell” may be understood to equally refer to the cell 120.

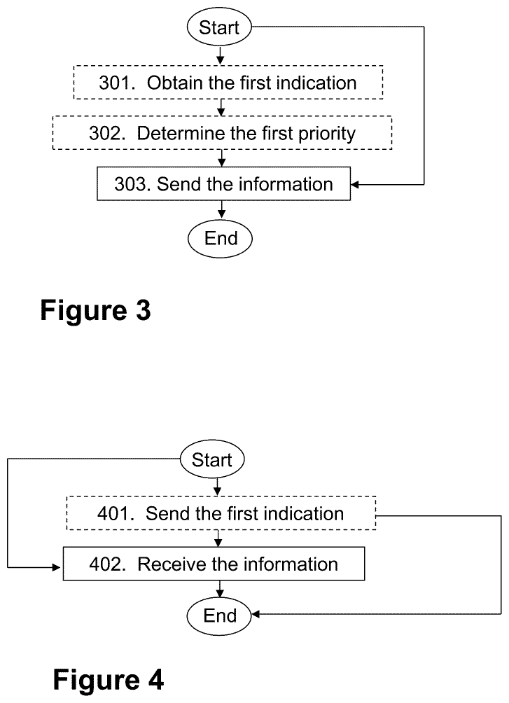

Embodiments of a method, performed by a wireless device, such as the wireless device 130, will now be described with reference to the flowchart depicted in FIG. 3. The method may be understood to be for handling information. The wireless device 130 operates in a wireless communications network, such as the wireless communications network 100. The method may be understood to be computer-implemented.

In some embodiments, the wireless communications network 100 may support, or operate in, New Radio (NR).

The method comprises one or more of the following actions. In particular embodiments, the method comprises Action 303, in other examples, the method may comprise Action 301 and Action 303. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 3. In FIG. 3 optional actions in some embodiments may be represented with dashed lines. In some embodiments, the actions may be performed in a different order than that depicted FIG. 3.

### Action 301

Embodiments herein may be performed according to the following scenarios and assumptions. In a UE buffer, such as a buffer of the wireless device 130, there may be more than one different LCID configured with a same or different priority, and each LCID may have data to be scheduled. In addition, the network node 110 may receive delay information per logical channel ID or logical channel group. The delay information may be understood to indicate how long the information has been stored in the buffer, e.g., queuing time in the buffer may be over some threshold delay time limit.

The delay information may be an absolute value of a remaining latency budget, or elapsed time, of corresponding data or an indication of its range. The remaining latency budget may be understood as a delay requirement-packet arrival time. For example, a different range of remaining latency budget may be predefined, and each range may have an index, which may be referred to as a delay bucket index. In uplink, the wireless device 130 may report the delay bucket index if there is any data which belongs to the corresponding delay bucket index. In this way, the network node 110 may be aware of how much data with what range of latency budget may be present in the wireless device 130.

In this Action 301, the wireless device 130 may obtain a first indication.

Obtaining may comprise receiving, e.g., via the first link 141, from the network node 110 or another network node, or device, or retrieving, e.g., from a memory.

The first indication may be of a first priority. The first priority may be for the wireless device 130 to send information, e.g., to the network node 110. The information may comprise at least one of: data and one or more packets.

The first priority may be based on a delay in the transmission of the information, that is, the sending of the information. Particularly, the first indication may indicate a delay left, e.g., PDB minus queuing time, may be considered to assign the first priority, or a weight, for selecting the data of a given logical channel. The delay may be, e.g., a remaining latency budget.

The first priority may be independent of a second priority assigned to an identity of a logical channel used for the sending of the information, as will be described in Action 303, and a group of the logical channel. The identity of the logical channel may be LCID. The group of the logical channel may be LCG. The second priority may be understood as a default priority, or legacy priority, e.g., the existing logical channel prioritization (LCP), which may be understood to be based on assigning a fixed priority.

This may be understood to mean that if the wireless device 130 is configured with resources with a certain LCID, or if defined for the LCG, priority, that is, second priority, then those resources may have to prioritize data with relatively lower LCH/LCG priority provided that the data is delayed, e.g., the queuing time in the buffer may be over some threshold delay time limit.

There may be situations in which the network node 110 may indicate a delay bucket index, and more than 1 LCID may have data in the said bucket index. In this case, the wireless device 130 may select data first, that is, in a first chronological order within that delay bucket index, from the LCID which had the highest priority, that is, the highest second priority. If the LCIDs have the same priority, that is, the same second priority, the wireless device 130 may select data randomly from any LCID, or based on other parameters, such as the LCID having waited the longest, or which prioritized bit rate may have not been reached.

In some embodiments, the first indication may be at least one of the following.

According to a first option, the first indication may be obtained from the network node 110.

In one group of examples, the network indication may be in a different format. One format may be Layer 1 (L1) signaling, e.g., Downlink Control Information (DCI). In some examples, the DCI may be related dynamic grant allocation of configured grant activation for Type 2 Configured Grant (CG). In other examples, the DCI may be a new DCI. Another format may be Layer 2 (L2) signaling, e.g., Medium Access Control (MAC) Control Element (CE). A further format may be Radio Resource Control (RRC) signaling. For example, allocating addition parameters in Logical Channel (LCH)/Logical Channel Group (LCG) RRC configuration, or indicating in RRC parameters for Type 1 and 2 CG.

According to a second option, the first indication may be indicating one or more delay buckets. In some particular embodiments, a plurality of delay buckets may be indicated in the first indication.

According to a third option, the first indication may be indicating a respective index of the one or more delay buckets. In the first group of examples, the network node 110 may indicate the wanted delay bucket index or indices in one or more corresponding grants for scheduling.

According to a fourth option, the first indication may be indicating one or more packet delay budgets (PDB).

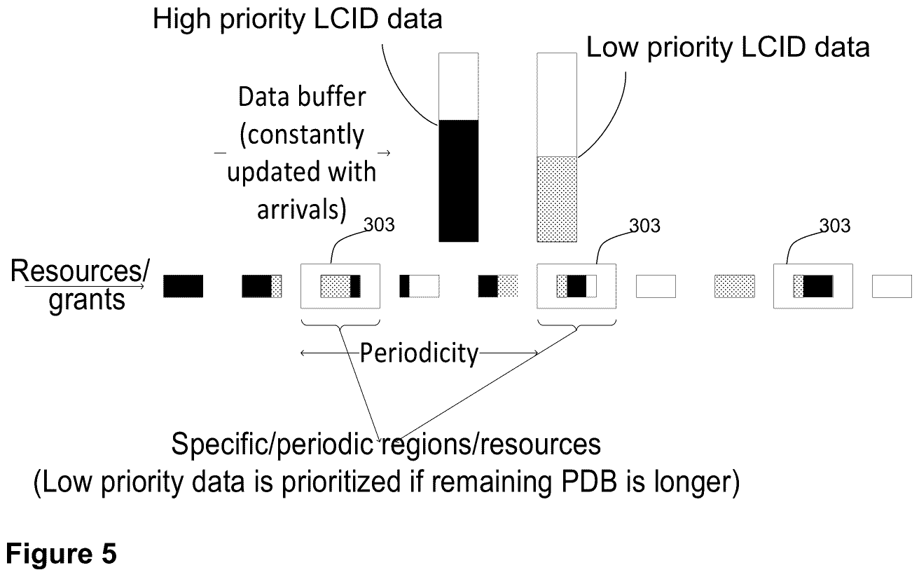

According to a fifth option, the first indication may be indicating one or more grants the first indication is to be applied to. The network node 110 may configure which grants or the number of grants that the wireless device 130 may have to apply the indicated delay bucket index to be prioritized to. As a non-limiting example, the grants framed in FIG. 5 may be considered examples of the one or more grants that the first indication may indicate the first indication may have to be applied to.

According to a sixth option, the first indication may be a priority parameter overriding the second priority assigned to the identity of the logical channel used for the sending of the information, as will be described in Action 303, and the group of the logical channel.

In another group of examples, instead of delay bucket index, the network node 110 may indicate the LCG or LCID corresponding to the wanted delay bucket index. In this case, the wireless device 130 may select data from the indicated LCG or LCID, which may potentially include data with low remaining PDB, but may be associated with low priority LCID, that is, with a low second priority. Therefore, the priority parameter may be understood to, in such examples, override the legacy, second priority that may be assigned by default to the LCID, that is, the fixed priority corresponding to the LCID.

According to a seventh option, the first indication may be a IchPriority indicator.

In one group of examples, the network node 110 may define a IchPriority parameter, in L1 or higher layer message, indicating the priority of the LCID which may override its default priority. For example, a default low priority LCID X may be assigned a new priority which may be greater than a high priority LCID Y during the allocation of a grant or in the grant message, e.g., DCI. Then wireless device 130, on this grant, may select data, e.g., for MAC PDU construction, first from LCID X and then LCID Y, as per their PBR values. In one option, the network node 110 may assign 1 bit or more bits or codewords, which may indicate whether the LCID priority may be set as default or updated for the grant. For instance, bit value ‘0’ of IchPriority for a given LCID may set the default priority, that is, the second priority, for the given LCID, e.g., set to priority defined in legacy releases or initial RRC configuration. The bit value ‘1’ of IchPriority for a given LCID may indicate, e.g., this LCID X data may be prioritized in MAC PDU construction for the given grant regardless of other LCID data, that is, according to the first priority of embodiments herein. The parameter IchPriority, indicating default or updated priority, may be associated to a specific LCID, thus the given LCID may also be included alongside in the parameter. The values for IchPriority indicator may be configured to be associated with one or more (LCH ID, LCH priority) pairs. For example, the value ‘0’ may be associated with (LCH ID #1, LCH priority X) while the value ‘1’ may be associated with {(LCH ID #1, LCH priority Y), (LCH ID #2, LCH priority Z)}. In the above groups of examples, the IchPriority indicator may indicate an absolute LCH priority the wireless device 130 may have to apply instead of the RRC configured value, or the IchPriority indicator may indicate an offset/delta LCH priority to be added/subtracted to/from the RRC configured value.

In further other groups of examples, the IchPriority indicator may indicate a list of LCH IDs, e.g., [LCH ID #1, LCH ID #2, LCH ID #3] where the LCHs in the list may be regarded to be in decreasing/increasing LCH priority order. That is, the first LCH in the list may have the highest LCH priority among the LCHs in the indicated list. In some such groups of examples, the wireless device 130 may only multiplex data from LCHs in the indicated list. In other groups of examples, the wireless device 130 may first multiplex data from LCHs in the indicated list in order of the indicated LCH priority and, if more data fits in the MAC PDU, the wireless device 130 may additionally multiplex data from other LCHs using legacy procedure.

### Action 302

In this Action 302, the wireless device 130 may determine the first priority.

Determining may be understood as calculating, selecting or deriving.

The determining in this Action 302 may be based on the obtained first indication. That is, based on the obtained first indication, as described in the previous Action 301, the wireless device 130 may derive in which order to schedule the information in the grants or resources that may be available, that is, which information, e.g., from which LCID, to select in the first place, and which to select next, if resources may still be available. Some examples of such selection are described in the next Action 303.

In some particular embodiments, a plurality of delay buckets may be indicated in the first indication. In such embodiments, the first priority may be based on a respective delay of the plurality of delay buckets.

In another group of examples, the network node 110 may indicate more than one delay bucket index. In this case, the order in which the wireless device 130 may take data from each of the indicated bucket indexes may be implicitly derived, e.g., delay bucket indices which represent the least PDB left, e.g., remaining PDB, may represent a higher priority than those having longer PDB left, e.g., remaining PDB, or the priority may have been explicitly provided via other signaling, e.g., Radio Resource Control (RRC), or may be explicitly derived, e.g., the message, e.g., L1, also included an explicit indication about the order or priority in which data may be taken from the bucket indices. Once the index may be selected, the wireless device 130 may take the data from the LCID(s) as explained above. If and when all LCIDs having data in the selected index are served, the wireless device 130 may select the next index and may apply the same procedure to select the data from the LCIDs which may have data in the index. For example, if the Downlink Control Information (DCI) indicates 2 buckets to be served first, the wireless device 130 may take the data from all LCID which may have data in the first bucket, then it may go to the second bucket and may do the same for all LCIDs which may have data in the second bucket.

### Action 303

In this Action 303, the wireless device 130 sends the information.

The sending in this Action 303 is to the network node 110 operating in the wireless communications network 100.

The sending in this Action 303 may be, e.g., transmitting, and may be performed, e.g., via the first link 141.

The sending in this Action 303 of the information is with a priority, that is, the first priority.

The first priority is a) based on the delay, e.g., the remaining latency budget, in the transmission of the information, and b) independent of the second priority assigned to the identity of a logical channel used for the sending in this Action 303 of the information and the group of the logical channel.

The sending in this Action 303 may be performed based on the obtained first indication.

The sending in this Action 303 of may be performed based on the determined first priority.

In some embodiments, the first priority may be a priority applied in a first order. In some embodiments, with the proviso a same delay, e.g., a same remaining latency budget, in the transmission may apply to a plurality of sets of information, each of the sets in the plurality having at least one of: different identities of logical channel, and different groups of logical channel, the second priority may be applied in a subsequent order. The second priority may be based, within each group having a same delay, e.g., the same remaining latency budget, in transmission, on a respective priority assigned to the at least one of different identities of logical channel, and different groups of logical channel.

In some embodiments, the sending in this Action 303 may be on a set of time-frequency resources having insufficient capacity to transmit all information in the buffer of the wireless device 130. In some of such embodiments, the sending in this Action 303 may be at least one of: a) based on one or more conditions, b) based on one or more periodic grants, regions or locations of time-frequency resources, and c) multiplexing a plurality of logical channels of different priorities in the same set of time-frequency resources.

With respect to the second option, in one group of examples, the network indication, that is, the first indication, may apply to dynamic grants or instantaneous grants which may be single-PUSCH or multi-PUSCH dynamic grants, pre-configured grants, e.g., Type 1 or 2 CG and/or specific grants or regions of a time-frequency resource grid. For example, in these regions, delayed low-priority (LP) data may be prioritized over high-priority (HP) data, whereas outside these regions, the HP data may be always prioritized.

In one example, using the above groups of examples, the selective/periodic/pre-configured regions/grants may be configured where in these grants, the wireless device 130 may select first the data associated with low remaining PDB but low priority LCID over the data associated with high priority LCID. An example of this will be described in relation to FIG. 5, where the wireless device 130 may select first data associated with high priority LCID in the grants except in certain periodic locations/regions, where onto those resources, data with low priority LCID with low remaining PDB may be selected first. In these options, when low priority LCID data is selected, it may be assumed that the data of high priority LCIDs has longer remaining PDB compared to low priority LCID data.

For example, in embodiments wherein the first indication may indicate a delay bucket, if the grant size is not big enough to carry all data which belongs to the indicated delay bucket, the wireless device 130 may prioritize data from the highest priority LCID which may contain the indicated delay. If the data in a given LCID cannot fit to the grant, the wireless device 130 may prioritize the most urgent packet. In another way, the network node 110 may configure the amount of data from different LCIDs or LCG if they have the same delay bucket index and the wireless device 130 may take data from different LCIDs or LCG with the configured amount to utilize the grant.

With respect to the first option, the one or more conditions may be based on a priority bit rate value. Based on configured PriorityBitRate (PBR) values, in the legacy scenario, the MAC PDU may be filled with low priority LCID data if any resource may be left after filling the grant first with high priority LCID data, up to PBR. However, when embodiments herein may be applied, then on the indicated specific regions, the low priority LCID data may be filled first up to PBR, then high priority LCID data may be filled in the grant/MAC PDU based on defined PBR values, policies, etc. In an extended group of examples, instead of periodic regions/grants/resources, where low priority LCID data may be selected first before high priority LCID data, in the MAC PDU, converted to transport block, to be transmitted over the resource data, the regions/grants/resources may be defined with some pattern over a time-frequency resource grid.

Also with respect to the first option, the one or more conditions may be based the first priority being enabled. In one group of examples, two PBR values may be configured for data with low priority LCID, say PBR1_LP and PBR2_LP. For instance, when embodiments herein may be not implemented, or disabled, then on the grant, first high priority LCID data may be selected, then low priority LCID data in the MAC PDU, e.g., of size PBR1_LP value. On the other hand, if embodiments herein are implemented or enabled, then first low priority LCID data may be selected up to size PBR2_LP, a different configured PBR value than PBR1_LP, and then the wireless device 130 may fill the PDU with high priority LCID data. Note, in one option, PBR1_LP=PBR2_LP.

With respect to the third option, as stated earlier, in further other groups of examples, the IchPriority indicator may indicate a list of LCH IDs, e.g., [LCH ID #1, LCH ID #2, LCH ID #3] where the LCHs in the list may be regarded to be in decreasing/increasing LCH priority order. That is, the first LCH in the list may have the highest LCH priority among the LCHs in the indicated list. In some such groups of examples, the wireless device 130 may only multiplex data from the LCHs in the indicated list. In other groups of examples, the wireless device 130 may first multiplex data from the LCHs in the indicated list in the order of the indicated LCH priority and, if more data fits in the MAC PDU, the wireless device 130 may additionally multiplex data from other LCHs using the legacy procedure.

In some embodiments, at least one of the following options may apply. According to a first option, the delay may be the remaining latency budget. According to a second option, as mentioned earlier, the one or more conditions may be based on the priority bit rate value. According to a third option, as also mentioned earlier, the one or more conditions may be based the first priority being enabled. According to a fourth option, the time-frequency resources may be a transport block.

According to examples of embodiments herein, when the wireless device 130 may receive the indicated delay bucket index, it may prioritize data belonging to the indicated delay bucket index regardless of LCID or LCG. That is, as stated earlier, independent of the second priority assigned to the identity of the logical channel used for the sending of the information in this Action 303, and the group of the logical channel.

If the wireless device 130 has been able to serve all the LCIDs which had data in the indicated index(es), and if there are still resources/grant left, the wireless device 130 may continue serving the LCIDs based on the priority of the LCID, that is, based on the second priority as in legacy, or may select further delay bucket indices according to an implicit or explicit priority order for delay bucket index list.

In the above groups of examples, the network node 110 indication for prioritization, that is, the first indication, may be applied to more than one carrier, e.g., cross-carrier scheduling. In that case, the first indication may explicitly include the applied carrier information on the first indication and the wireless device 130 may apply the received carrier information with the corresponding indication.

In some embodiments, at least one of the following may apply: a) the information may comprise at least one of: data and one or more packets, b) the wireless communications network 100 may support extended reality (XR) and c) the wireless communications network 100 may support XR in Fifth Generation, 5G.

By the wireless device 130 sending the information with the first priority based on the delay in the transmission of the information in this Action 303, embodiments herein may support enhanced UL delay-aware scheduling with dynamic logical channel prioritization. Embodiments herein, may be understood to reduce error rate for low priority data, which may not get a chance to transmit due to presence of high priority data present alongside. The situation may occur in a very like scenario where macros or cells may be serving eMBB and XR traffic from a user, e.g., uplink. In XR applications, it is well expected to have multiple traffic flows, e.g., multiple video streams, audio, pose, etc., in addition to legacy Mobile BroadBand (MBB) traffic. Therefore, Release (Rel)-19 may further enhance delay-based prioritization when multiple traffic flows may be present. This may include the new signalling for dynamic prioritization and changes of existing LCP accordingly. To increase capacity, UL scheduling can be improved to make better use of the delay information and more flexibly assign priorities to traffic.

Embodiments of a method, performed by a network node, such as the network node 110 will now be described with reference to the flowchart depicted in FIG. 4. The method may be understood to be for handling the information. The network node 110 operates in a wireless communications network, such as the wireless communications network 100. The method may be understood to be computer-implemented.

The first method may comprise one or more of the following actions. In a particular non-limiting embodiment, Action 402 may be performed. In some embodiments, all the actions may be performed. It should be noted that the examples herein may be not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the network node 110 is depicted in FIG. 4. In FIG. 4, optional actions in some embodiments may be represented with dashed lines.

The detailed description of some of the following corresponds to the same references provided above, in relation to the actions described for the wireless device 130 and will thus not be repeated here to simplify the description. For example, the wireless communications network 100 may support New Radio (NR).

### Action 401

In this Action 401, the network node 110 may send the first indication. The first indication may be of the first priority.

The sending in this Action 401 may be to the wireless device 130.

The sending in this Action 401 may be performed, e.g., via the first link 141.

In some examples, the first indication may be at least one of: a) indicating the one or more delay buckets, b) indicating the respective index of the one or more delay buckets, c) indicating the one or more packet delay buckets (PDB), d) indicating the one or more grants the first indication is to be applied to, e) the priority parameter overriding the second priority assigned to the identity of the logical channel used for the sending of the information and the group of the logical channel, and f) the IchPriority indicator.

In some examples, the plurality of delay buckets may be indicated in the first indication; the first priority may be based on the respective delay of the plurality of delay buckets.

### Action 402

In this Action 402, the network node 110 receives the information.

The receiving in this Action 402 is from the wireless device 130 operating in the wireless communications network 100.

The receiving in this Action 402 may be performed, e.g., via the first link 141.

The receiving in this Action 402 of the information is with the priority, e.g., the first priority. The first priority is: a) based on the delay in the transmission of the information; the delay may be, e.g., the remaining latency budget, and b) independent of the second priority assigned to the identity of the logical channel used for the receiving in this Action 402 of the information and the group of the logical channel.

The identity of the logical channel may be LCID.

The group of the logical channel may be LCG.

In some embodiments, the first priority may be the priority applied by the wireless device 130 in the first order. In some embodiments, with the proviso the same delay, e.g., the same remaining latency budget, in the transmission, that is, the sending of the information, may apply to the plurality of sets of information, each of the sets in the plurality having at least one of: the different identities of logical channel, and the different groups of logical channel, the second priority may be applied in the subsequent order. The second priority may be based, within each group having the same delay in transmission, on the respective priority assigned to the at least one of different identities of logical channel, and different groups of logical channel.

In some embodiments, the receiving in this Action 402 may be on the set of time-frequency resources having insufficient capacity to transmit all information in the buffer of the wireless device 130. In some of such embodiments, the receiving in this Action 402 may be at least one of: a) based on the one or more conditions, b) based on the one or more periodic grants, regions or locations of time-frequency resources, and c) multiplexing the plurality of logical channels of different priorities in the same set of time-frequency resources.

In some embodiments, at least one of the following may apply: a) the delay may be the remaining latency budget, b) the one or more conditions may be based on the priority bit rate value, c) the one or more conditions may be based the first priority being enabled, and d) the time-frequency resources may be the transport block.

In some embodiments, at least one of the following may apply: a) the information may comprise at least one of: data and one or more packets, b) the wireless communications network 100 may support extended reality (XR), and c) the wireless communications network 100 may support XR in Fifth Generation (5G).

The receiving in this Action 402 may be performed based on the sent first indication.

FIG. 5 is a schematic diagram depicting a non-limiting example of embodiments herein, where the wireless device 130, a UE, selects first, that is in chronological first place, data associated with a high priority LCID in the grants except in certain periodic locations/regions, shown with white boxes, where onto those resources, data with low priority LCID with low remaining PDB may be selected first. In these options, when low priority LCID data is selected, it may be assumed, the data of the high priority LCIDs has longer remaining PDB compared to low priority LCID data. In FIG. 5, resources/grants are depicted as horizontal rectangles. Data having a high priority LCID, that is, a high second priority is depicted in solid black, and data having a low priority LCID, that is, a low second priority, is depicted with a dotted pattern. The arrival of data is schematically depicted in vertical rectangles. In the resources/grants, the wireless device 130, a UE, selects first, that is in chronological first place, data associated with a high priority LCID, only after all the high priority data is selected, in the depicted example, in the second, fifth and eighth horizontal rectangles from the left, may the wireless device 130 select the low priority data. However, in the framed specific, or periodic, regions or resources, the data may be sent according to Action 303. That is, low second priority data may be prioritized, e.g., selected first, if the remaining PBD of the low second priority data is longer than that of the high second priority data. In the non-limiting example of FIG. 5, the resources/grants are configured with a periodicity, as indicated by the bidirectional arrow.

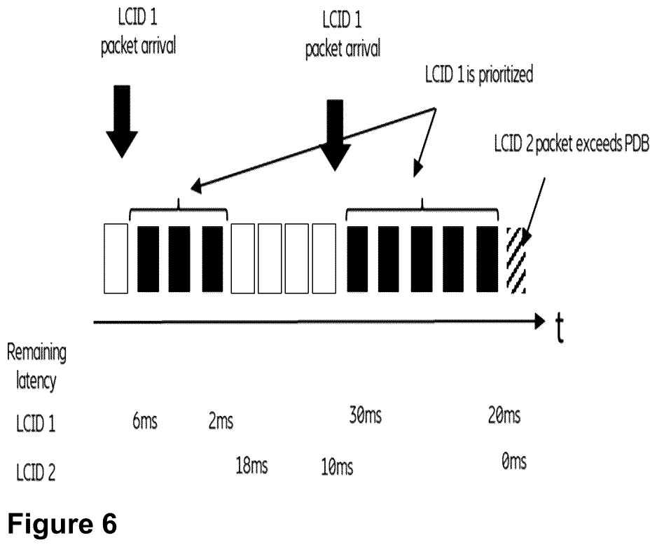

An enhancement of embodiments herein may be understood to be supporting improved delay-aware scheduling in uplink. FIG. 6 is a schematic diagram illustrating the issue of existing logical channel prioritization (LCP) for delay based prioritization in uplink scheduling. In other words, FIG. 6 illustrates with an example a challenge of existing methods embodiments herein are trying to address. In Rel-18, it was agreed to have delay information reported to a network, in order to support delay-aware scheduling. However, the existing LCP is based on assigning a fixed priority level and the bucket size for each LCID. The bucket size may be understood to refer to the amount of bits to be served in a given grant. This may be calculated based on PBR and BSD. As a rule, the grant may be filled by data in each LCID by priority level, highest priority first, given their bucket may allow it. This may give a restriction to prioritize packets to be delivered urgently, although they may belong to the lower priority logical channel. This may happen when a UE may have multiple flows or services which may have a packet delay budget (PDB) and thus, as the remaining delay budget becomes shorter in time, that data may have a higher priority. FIG. 6 illustrates an example where the last packet of LCID 2 is delayed while all packets from LCID 1 are prioritized. The lower part of FIG. 6 indicates the remaining latency for the packets belonging to LCID 1, depicted as solid black rectangles in the top of FIG. 6, and LCID 2, depicted as solid white rectangles in the bottom of the Figure. The first thick arrow starting from the left of FIG. 6 marks the arrival of LCID 1 packet arrival. The LCID 1 packets are encompassed in backets. At the moment of arrival, the remaining latency of the LCID 1 packets is 6 ms. After the last packet of this first set is transmitted, the remaining latency is 2 ms. A set of LCID 2 packets is then transmitted with a remaining latency of 18 ms. After the last packet of this set is transmitted, the remaining latency is 10 ms. The second thick arrow starting from the left of FIG. 6 marks the arrival of a second set of LCID 1 packets. At the moment of arrival, the remaining latency of the LCID 1 packets is 30 ms. After the last packet of this second set is transmitted, the remaining latency is 20 ms. The last packet of LCID 2 is eventually delayed too much since LCID 1 packets are always prioritized. The last LCID 2 packet exceeds the PDB. Existing specification has a basic tool to allow dynamic priority indication in a physical layer channel, e.g., from gNB to a UE. However, it may be meaningful only when the maximum two logical channels may be present. That is, while the existing indication may be understood to be a binary indication, high or low priority, embodiments herein may be understood to enable to indicate what specific LCID may need to be prioritized.

As a summarized overview of the foregoing, according to embodiments herein, delay or queuing impact may be considered in assigning a priority. Particularly, a delay left, e.g., PDB minus queuing time, may be considered to assign a priority or a weight for selecting the data of the given logical channel.

Certain embodiments disclosed herein may provide one or more of the following technical advantage(s), which may be summarized as follows.

Embodiments herein, may be understood to reduce error rate for low priority data which may not get a chance to transmit due to presence of high priority data present alongside. The situation may occur in a very like scenario where macros or cells may be serving eMBB and XR traffic from a user, e.g., uplink.

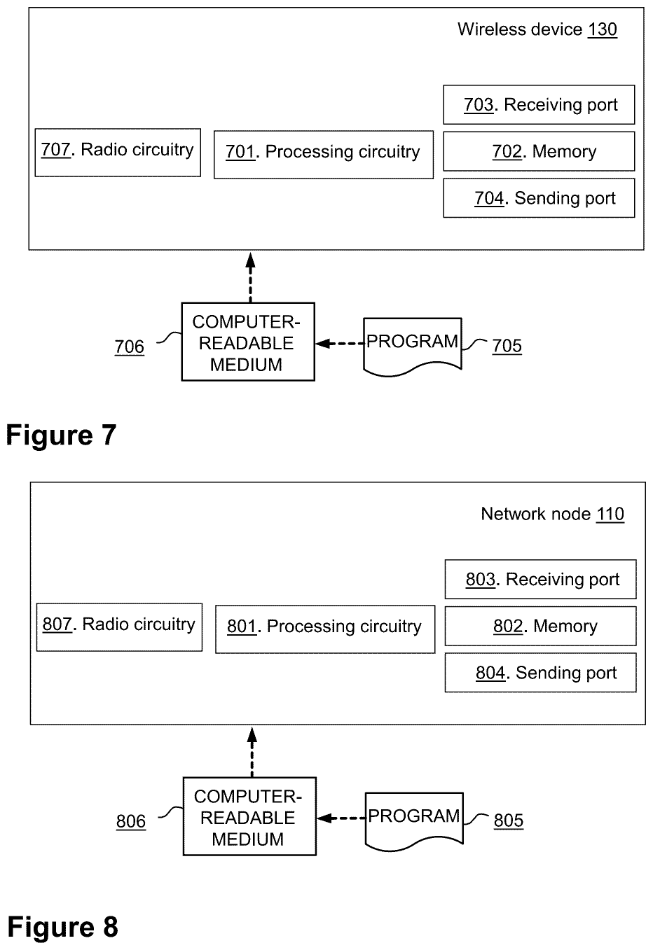

FIG. 7 depicts an example of the arrangement that the wireless device 130 may comprise to perform the method actions described above in relation to FIG. 3, e.g., in relation to FIG. 5. The wireless device 130 may be understood to be for handling the information. The wireless device 130 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the wireless device 130 and will thus not be repeated here. For example, the wireless communications network 100 may be a 5G network.

The wireless device 130 is configured and/or operable to perform the sending in Action 303, e.g. by means of a processing circuitry 701 within the wireless device 130, configured to, send information to the network node 110 configured to operate in the wireless communications network 100. The sending of the information is configured to be with the first priority. The first priority is configured to be a) based on the delay, e.g., the remaining latency budget, in the transmission of the information, and b) independent of the second priority configured to be assigned to the identity of the logical channel configured to be used for the sending of the information and the group of the logical channel.

In some embodiments, the first priority may be configured to be the priority configured to be applied in the first order, and, with the proviso the same delay in the transmission may be configured to apply to the plurality of sets of information, each of the sets in the plurality having at least one of: different identities of logical channel, and different groups of logical channel, the second priority may be configured to be applied in the subsequent order. The second priority may be configured to be based, within each group having the same delay in transmission, on the respective priority configured to be assigned to the at least one of different identities of logical channel, and different groups of logical channel.

In some embodiments, the wireless device 130 may be configured with at least one of the following two configurations.

In some embodiments, the wireless device 130 may be configured and/or operable to perform the obtaining in Action 301, e.g. by means of the processing circuitry 701 within the wireless device 130, configured to, obtain the first indication of the first priority, and the sending may be configured to be performed based on the first indication configured to be obtained.

In some embodiments, the wireless device 130 may be configured and/or operable to perform the determining in Action 302, e.g., by means of the processing circuitry 701, configured to, determine the first priority based on the first indication configured to be obtained. The sending may be configured to be performed based on the first priority configured to be determined.

In some embodiments, the first indication may be configured to be at least one of the following: a) obtained from the network node 110, b) indicating the one or more delay buckets, c) indicating the respective index of the one or more delay buckets, d) indicating the one or more packet delay budgets (PDB), e) indicating the one or more grants the first indication may have to be applied to, f) the priority parameter configured to override the second priority configured to be assigned to the identity of the logical channel configured to be used for the sending of the information and the group of the logical channel, and g) the IchPriority indicator.

In some embodiments, the plurality of delay buckets may be configured to be indicated in the first indication, and the first priority may be configured to be based on the respective delay of the plurality of delay buckets.

In some embodiments, the sending may be configured to be on the set of time-frequency resources having insufficient capacity to transmit all information in the buffer of the wireless device 130, and the sending may be configured to be at least one of: a) based on the one or more conditions, b) based on the one or more periodic grants, regions or locations of time-frequency resources, and c) multiplexing the plurality of logical channels of different priorities in the same set of time-frequency resources.

In some embodiments, at least one of the following may apply: a) the delay may be configured to be the remaining latency budget, b) the one or more conditions may be configured to be based on the priority bit rate value, c) the one or more conditions may be configured to be based on the first priority being enabled, and d) the time-frequency resources may be configured to be the transport block.

In some embodiments, at least one of the following may apply: a) the information may be configured to comprise at least one of: data and one or more packets, b) the wireless communications network 100 may be configured to support XR, and c) the wireless communications network 100 may be configured to support XR in 5G.

The embodiments herein in the wireless device 130 may be implemented through one or more processors, such as a processing circuitry 701 in the wireless device 130 depicted in FIG. 7, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 130. One such carrier may be in the form of a CD ROM disc. It is however feasible with other data carriers such as a memory stick. The computer program code may furthermore be provided as pure program code on a server and downloaded to the wireless device 130.

The processing circuitry 701 may be configured to, or operable to, perform the method actions according to FIG. 3 and/or FIG. 5.

The wireless device 130 may further comprise a memory 702 comprising one or more memory units. The memory 702 is arranged to be used to store obtained information, store data, configurations, schedulings, and applications etc. to perform the methods herein when being executed in the wireless device 130.

In some embodiments, the wireless device 130 may receive information from, e.g., the network node 110 or another structure in the wireless communications network 100, through a receiving port 703. In some embodiments, the receiving port 703 may be, for example, connected to one or more antennas in wireless device 130. In other embodiments, the wireless device 130 may receive information from another structure in the wireless communications network 100 through the receiving port 703. Since the receiving port 703 may be in communication with the processing circuitry 701, the receiving port 703 may then send the received information to the processing circuitry 701. The receiving port 703 may also be configured to receive other information.

The processing circuitry 701 in the wireless device 130 may be further configured to transmit or send information to e.g., the network node 110 or another structure in the wireless communications network 100, through a sending port 704, which may be in communication with the processing circuitry 701, and the memory 702.

Those skilled in the art will also appreciate that the processing circuitry 701 described above may comprise a combination of analog and digital modules, and/or one or more processors configured with software and/or firmware, e.g., stored in memory, that, when executed by the one or more processors such as the processing circuitry 701, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the wireless device 130 may be configured to perform the actions of FIG. 3 and/or FIG. 5 with respective units that may be implemented as one or more applications running on one or more processors such as the processing circuitry 701.

Thus, the methods according to the embodiments described herein for the wireless device 130 may be respectively implemented by means of a computer program 705 product, comprising instructions, i.e., software code portions, which, when executed on at least one processing circuitry 701, cause the at least one processing circuitry 701 to carry out the actions described herein, as performed by the wireless device 130. The computer program 705 product may be stored on a computer-readable storage medium 706. The computer-readable storage medium 706, having stored thereon the computer program 705, may comprise instructions which, when executed on at least one processing circuitry 701, cause the at least one processing circuitry 701 to carry out the actions described herein, as performed by the wireless device 130. In some embodiments, the computer-readable storage medium 706 may be a non-transitory computer-readable storage medium, such as a CD ROM disc, or a memory stick. In other embodiments, the computer program 705 product may be stored on a carrier containing the computer program 705 just described, wherein the carrier is one of an electronic signal, optical signal, radio signal, or the computer-readable storage medium 706, as described above.

The wireless device 130 may comprise a communication interface configured to facilitate communications between the wireless device 130 and other nodes or devices, e.g., the network node 110 or another structure in the wireless communications network 100. The interface may, for example, include a transceiver configured to transmit and receive radio signals over an air interface in accordance with a suitable standard.

In other embodiments, the wireless device 130 may also comprise a radio circuitry 707, which may comprise e.g., the receiving port 703 and the sending port 704. The radio circuitry 707 may be configured to set up and maintain at least a wireless connection with the network node 110 or another structure in the wireless communications network 100. Circuitry may be understood herein as a hardware component.

Hence, embodiments herein also relate to the wireless device 130 comprising the processing circuitry 701 and the memory 702, said memory 702 containing instructions executable by said processing circuitry 701, whereby the wireless device 130 is operative to perform the actions described herein in relation to the wireless device 130, e.g., in FIG. 3 and/or FIG. 5.

FIG. 8 depicts an example of the arrangement that the network node 110 may comprise to perform the method actions described above in relation to FIG. 4, e.g., in relation to FIG. 5. The network node 110 may be understood to be for handling the information. The network node 110 is configured to operate in the wireless communications network 100.

Several embodiments are comprised herein. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the network node 110 and will thus not be repeated here. For example, the wireless communications network 100 may be a 5G network.

In FIG. 8, optional units are indicated with dashed boxes.

The network node 110 is configured and/or operable to perform the receiving in Action 402, e.g. by means of a processing circuitry 801, configured to, receive the information from the wireless device 130 configured to operate in the wireless communications network 100. The receiving of the information is configured to be with the first priority. The first priority is configured to be a) based on the delay in the transmission of the information, and b) independent of the second priority configured to be assigned to the identity of the logical channel configured to be used for the receiving of the information and the group of the logical channel.

In some embodiments, the first priority may be configured to be the priority configured to be applied by the wireless device 130 in the first order, and, with the proviso the same delay in the transmission may be configured to apply to the plurality of sets of information, each of the sets in the plurality having at least one of: different identities of logical channel, and different groups of logical channel, the second priority may be configured to be applied in the subsequent order. The second priority may be configured to be based, within each group having the same delay in transmission, on the respective priority configured to be assigned to the at least one of different identities of logical channel, and different groups of logical channel.

In some embodiments, the network node 110 may be further configured with the following configuration.

In some embodiments, the network node 110 may be configured and/or operable to perform the sending in Action 401, e.g. by means of the processing circuitry 801 within the network node 110, configured to, send the first indication of the first priority to the wireless device 130, and the receiving may be configured to be performed based on the first indication configured to be sent.

In some embodiments, the first indication may be configured to be at least one of the following: a) indicating the one or more delay buckets, b) indicating the respective index of the one or more delay buckets, c) indicating the one or more packet delay budgets (PDB), d) indicating the one or more grants the first indication may have to be applied to, e) the priority parameter configured to override the second priority configured to be assigned to the identity of the logical channel configured to be used for the sending of the information and the group of the logical channel, and f) the IchPriority indicator.

In some embodiments, the plurality of delay buckets may be configured to be indicated in the first indication, and the first priority may be configured to be based on the respective delay of the plurality of delay buckets.

In some embodiments, the receiving may be configured to be on the set of time-frequency resources having insufficient capacity to transmit all information in the buffer of the wireless device 130, and the receiving may be configured to be at least one of: a) based on the one or more conditions, b) based on the one or more periodic grants, regions or locations of time-frequency resources, and c) multiplexing the plurality of logical channels of different priorities in the same set of time-frequency resources.

In some embodiments, at least one of the following may apply: a) the delay may be configured to be the remaining latency budget, b) the one or more conditions may be configured to be based on the priority bit rate value, c) the one or more conditions may be configured to be based on the first priority being enabled, and d) the time-frequency resources may be configured to be the transport block.

In some embodiments, at least one of the following may apply: a) the information may be configured to comprise at least one of: data and one or more packets, b) the wireless communications network 100 may be configured to support XR, and c) the wireless communications network 100 may be configured to support XR in 5G.

The embodiments herein in the network node 110 may be implemented through one or more processors, such as a processing circuitry 801 in the network node 110 depicted in FIG. 8, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The processing circuitry 801 may be configured to, or operable to, perform the method actions according to FIG. 4 and/or FIG. 5.

The network node 110 may further comprise a memory 802 comprising one or more memory units. The memory 802 is arranged to be used to store obtained information, store data, configurations, schedulings, and applications etc. to perform the methods herein when being executed in the network node 110.

In some embodiments, the network node 110 may receive information from, e.g., the wireless device 130 and/or another structure in the wireless communications network 100, through a receiving port 803. In some embodiments, the receiving port 803 may be, for example, connected to one or more antennas in network node 110. In other embodiments, the network node 110 may receive information from another structure in the wireless communications network 100 through the receiving port 803. Since the receiving port 803 may be in communication with the processing circuitry 801, the receiving port 803 may then send the received information to the processing circuitry 801. The receiving port 803 may also be configured to receive other information.

The processing circuitry 801 in the network node 110 may be further configured to transmit or send information to e.g., the wireless device 130 and/or another structure in the wireless communications network 100, through a sending port 804, which may be in communication with the processing circuitry 801, and the memory 802.

Those skilled in the art will also appreciate that the processing circuitry 801 described above may comprise a combination of analog and digital modules, and/or one or more processors configured with software and/or firmware, e.g., stored in memory, that, when executed by the one or more processors such as the processing circuitry 801, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the network node 110 may be configured to perform the actions of FIG. 4 and/or FIG. 5 with respective units that may be implemented as one or more applications running on one or more processors such as the processing circuitry 801.

Thus, the methods according to the embodiments described herein for the network node 110 may be respectively implemented by means of a computer program 805 product, comprising instructions, i.e., software code portions, which, when executed on at least one processing circuitry 801, cause the at least one processing circuitry 801 to carry out the actions described herein, as performed by the network node 110. The computer program 805 product may be stored on a computer-readable storage medium 806. The computer-readable storage medium 806, having stored thereon the computer program 805, may comprise instructions which, when executed on at least one processing circuitry 801, cause the at least one processing circuitry 801 to carry out the actions described herein, as performed by the network node 110. In some embodiments, the computer-readable storage medium 806 may be a non-transitory computer-readable storage medium, such as a CD ROM disc, or a memory stick. In other embodiments, the computer program 805 product may be stored on a carrier containing the computer program 805 just described, wherein the carrier is one of an electronic signal, optical signal, radio signal, or the computer-readable storage medium 806, as described above.

The network node 110 may comprise a communication interface configured to facilitate communications between the network node 110 and other nodes or devices, e.g., the wireless device 130 and/or another structure in the wireless communications network 100. The interface may, for example, include a transceiver configured to transmit and receive radio signals over an air interface in accordance with a suitable standard.

In other embodiments, the network node 110 may also comprise a radio circuitry 807, which may comprise e.g., the receiving port 803 and the sending port 804. The radio circuitry 807 may be configured to set up and maintain at least a wireless connection with the wireless device 130 and/or another structure in the wireless communications network 100. Circuitry may be understood herein as a hardware component.

Hence, embodiments herein also relate to the network node 110 comprising the processing circuitry 801 and the memory 802, said memory 802 containing instructions executable by said processing circuitry 801, whereby the network node 110 is operative to perform the actions described herein in relation to the network node 110, e.g., in FIG. 4 and/or FIG. 5.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### Examples Related to Embodiments Herein

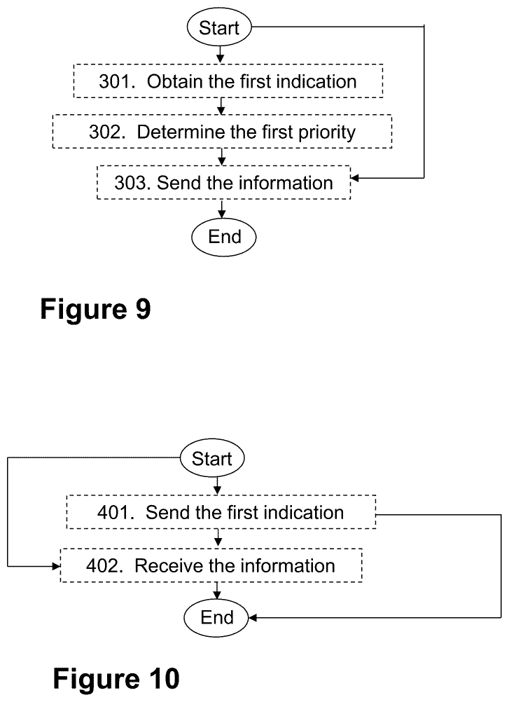

The wireless device 130 embodiments relate to FIG. 9, FIG. 5 and FIGS. 11-16.

A method, performed by a wireless device, such as the wireless device 130 is described herein. The method may be understood to be for handling information. The wireless device 130 may be operating in a wireless communications network, such as the wireless communications network 100.

In some embodiments, the wireless communications network 100 may support, or operate in, New Radio (NR).

The method may comprise one or more of the following actions. In particular examples, the method may comprise Action 303, in other examples, the method may comprise Action 301, yet in other examples, the method may comprise Action 301 and Action 303. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the wireless device 130 is depicted in FIG. 9. In FIG. 9 optional actions in some embodiments may be represented with dashed lines. In some embodiments, the actions may be performed in a different order than that depicted FIG. 9.
Sending 303 information. The wireless device 130 may be configured and/or operable to perform the sending in this Action 303.

The sending in this Action 303 may be to the network node 110 operating in the wireless communications network 100.

The sending in this Action 303 may be, e.g., transmitting, and may be performed, e.g., via the first link 141.

The sending in this Action 303 of the information may be with a priority, e.g., a first priority.

The first priority may be based on:
a) a delay in the transmission of the information, that is, the sending of the information; the delay may be, e.g., a remaining latency budget, and
b) independent of a second priority assigned to an identifier of a logical channel used for the sending 303 of the information and a group of the logical channel.

The identity of the logical channel may be LCID.

The group of the logical channel may be LCG.

In some examples, the first priority may be a priority applied in a first order. In some examples, with the proviso a same delay, e.g., a same remaining latency budget, in the transmission may apply to a plurality of sets of information, each of the sets in the plurality having at least one of: different identities of logical channel, and different groups of logical channel, the second priority may be applied in a subsequent order. The second priority may be based, within each group having a same delay in transmission, on a respective priority assigned to the at least one of different identities of logical channel, and different groups of logical channel.

In some examples, the sending in this Action 303 may be on a set of time-frequency resources having insufficient capacity to transmit all information in a buffer of the wireless device 130. In some of such examples, the sending in this Action 303 may be at least one of:
based on one or more conditions,
based on one or more periodic grants, regions or locations of time-frequency resources, and
multiplexing a plurality of logical channels of different priorities in the same set of time-frequency resources.

In some examples, at least one of the following may apply:
the delay may be a remaining latency budget,
the one or more conditions may be based on a priority bit rate value,
the one or more conditions may be based the first priority being enabled, and
the time-frequency resources may be a transport block.

In some examples, at least one of the following may apply:
the information may comprise at least one of: data and one or more packets,
the wireless communications network 100 may support extended reality, XR, and
the wireless communications network 100 may support XR in Fifth Generation, 5G.

In some embodiments, the method may further comprise one or more of the following actions:
Obtaining 301 a first indication. The wireless device 130 may be configured and/or operable to perform the obtaining in this Action 301.

Obtaining may comprise receiving, e.g., via the first link 141, from the network node 110 or another network node, or device, or retrieving, e.g., from a memory.

The first indication may be of the first priority.

The sending in Action 303 may be performed based on the obtained first indication.

In some examples, the first indication may be at least one of:
obtained from the network node 110,
indicating one or more delay buckets,
indicating a respective index of the one or more delay buckets,
indicating one or more delay bucket budgets,
indicating one or more packet delay buckets (PBD),
indicating one or more grants the first indication is to be applied to,
a priority parameter overriding second priority assigned to an identifier of a logical channel used for the sending 303 of the information and a group of the logical channel, and
an IchPriority indicator.

In some examples, a plurality of delay buckets may be indicated in the first indication; the first priority may be based on a respective delay of the plurality of delay buckets.
Determining 302 the first priority. The wireless device 130 may be configured and/or operable to perform the determining in this Action 302.

Determining may be understood as calculating, selecting or deriving.

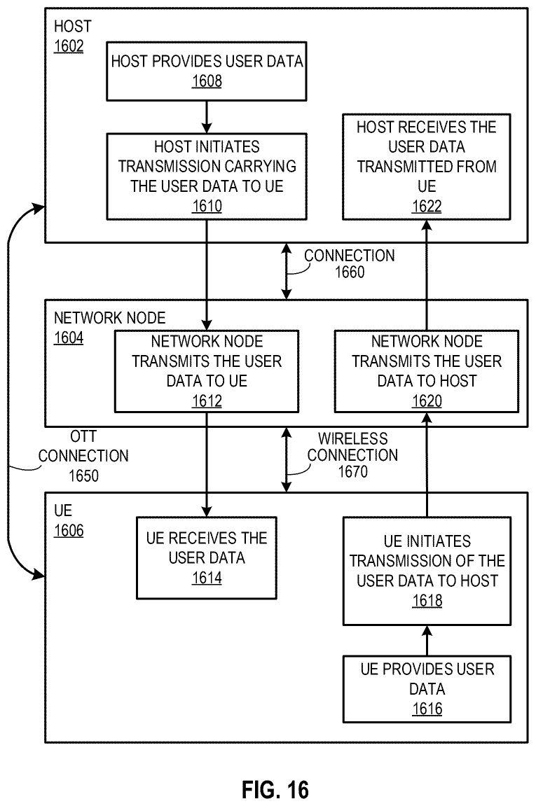

The determining in this Action 302 may be based on the obtained first indication.
The sending in Action 303 of may be performed based on the determined first priority.
The wireless device 130 may comprise an arrangement as shown in FIG. 7 or in FIG. 16.

The network node 110 embodiments relate to FIG. 10, FIG. 5 and FIGS. 11-16.

A method, performed by a network node, such as the network node 110 is described herein. The method may be understood to be for handling the information. The network node 110 may be operating in a wireless communications network, such as the wireless communications network 100.

The first method may comprise one or more of the following actions. In a particular non-limiting example, Action 401 may be performed, in other examples, Action 402 may be performed. In some embodiments, all the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the network node 110 is depicted in FIG. 10. In FIG. 10, optional actions in some embodiments may be represented with dashed lines.

The detailed description of some of the following corresponds to the same references provided above, in relation to the actions described for the wireless device 130 and will thus not be repeated here to simplify the description. For example, the wireless communications network 100 may support New Radio (NR).
Receiving 402 the information. The network node 110 may be configured and/or operable to perform the receiving in this Action 402.

The receiving in this Action 402 may be from the wireless device 130 operating in the wireless communications network 100.

The receiving in this Action 402 may be performed, e.g., via the first link 141.

The receiving in this Action 402 of the information may be with the priority, e.g., the first priority.

The first priority may be based on:
a) the delay in the transmission of the information; the delay may be, e.g., the remaining latency budget, and
b) independent of the second priority assigned to the identity of the logical channel used for the receiving in this Action 402 of the information and the group of the logical channel.

The identity of the logical channel may be LCID.

The group of the logical channel may be LCG.

In some examples, the first priority may be the priority applied in the first order. In some examples, with the proviso the same delay, e.g., the same remaining latency budget, in the transmission, that is, the sending of the information, may apply to the plurality of sets of information, each of the sets in the plurality having at least one of: the different identities of logical channel, and the different groups of logical channel, the second priority may be applied in the subsequent order. The second priority may be based, within each group having the same delay in transmission, on the respective priority assigned to the at least one of different identities of logical channel, and different groups of logical channel.

In some examples, the receiving in this Action 402 may be on the set of time-frequency resources having insufficient capacity to transmit all information in the buffer of the wireless device 130. In some of such examples, the receiving in this Action 402 may be at least one of:
based on the one or more conditions,
based on the one or more periodic grants, regions or locations of time-frequency resources, and
multiplexing the plurality of logical channels of different priorities in the same set of time-frequency resources.

In some examples, at least one of the following may apply:
the delay may be the remaining latency budget,
the one or more conditions may be based on the priority bit rate value,
the one or more conditions may be based the first priority being enabled, and
the time-frequency resources may be the transport block.

In some examples, at least one of the following may apply:
the information may comprise at least one of: data and one or more packets,
the wireless communications network 100 may support extended reality, XR, and
the wireless communications network 100 may support XR in Fifth Generation, 5G.

In some embodiments, the method may further, or alternatively, comprise the following actions:
Sending 401 the first indication. The network node 110 may be configured and/or operable to perform the sending in this Action 401.

The sending in this Action 401 may be to the wireless device 130.

The sending in this Action 401 may be performed, e.g., via the first link 141.

The first indication may be of the first priority.

The receiving in Action 402 may be performed based on the sent first indication.

In some examples, the first indication may be at least one of:
indicating the one or more delay buckets,
indicating the respective index of the one or more delay buckets,
indicating the one or more delay bucket budgets,
indicating the one or more packet delay buckets (PBD),
indicating the one or more grants the first indication is to be applied to,
the priority parameter overriding second priority assigned to the identity of the logical channel used for the sending of the information and the group of the logical channel, and
the IchPriority indicator.

In some examples, the plurality of delay buckets may be indicated in the first indication; the first priority may be based on the respective delay of the plurality of delay buckets.

The network node 110 may comprise an arrangement as shown in FIG. 8 or in FIG. 16.

### Further Extensions And Variations

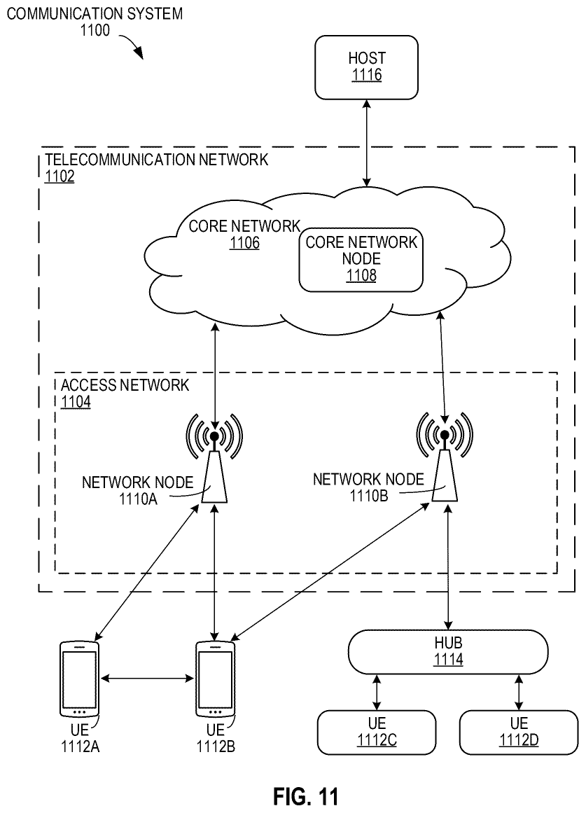

FIG. 11 shows an example of a communication system 1100 in accordance with some embodiments.

In the example, the communication system 1100, such as the wireless communications network 100, includes a telecommunication network 1102 that includes an access network 1104, such as a radio access network (RAN), and a core network 1106, which includes one or more core network nodes 1108. The access network 1104 includes one or more access network nodes, such as the network node 110. For example, network nodes 1110a and 1110b (one or more of which may be generally referred to as network nodes 1110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1102 includes one or more Open-RAN (ORAN) network nodes. An ORAN network node is a node in the telecommunication network 1102 that supports an ORAN specification (e.g., a specification published by the O-RAN Alliance, or any similar organization) and may operate alone or together with other nodes to implement one or more functionalities of any node in the telecommunication network 1102, including one or more network nodes 1110 and/or core network nodes 1108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections. Any of the UEs 1112a, 1112b, 1112c, and 1112d are examples of the wireless device 130.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The wireless device 130, exemplified in FIG. 11 as the UEs 1112 may be any of a wide variety of communication devices, including wireless devices arranged, configured, and/or operable to communicate wirelessly with the network node 110, exemplified in FIG. 11 as network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

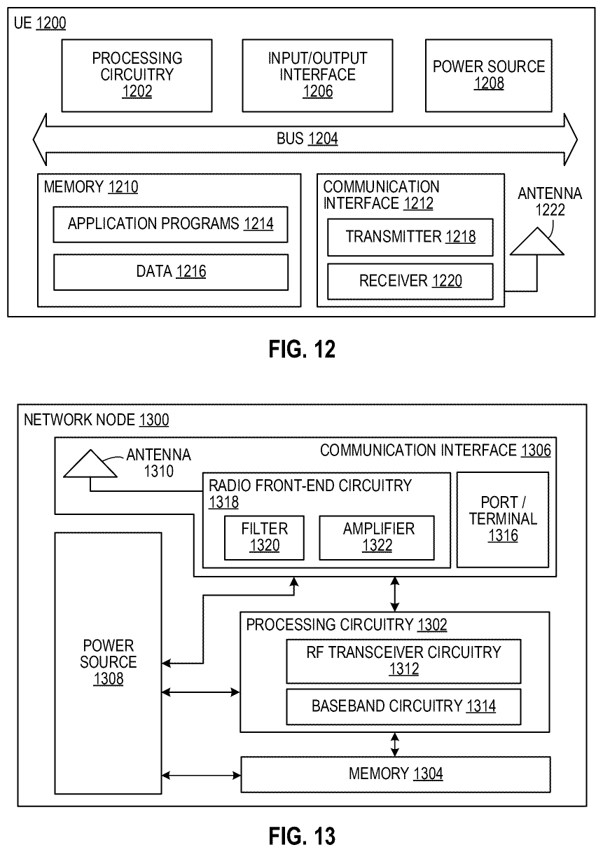

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

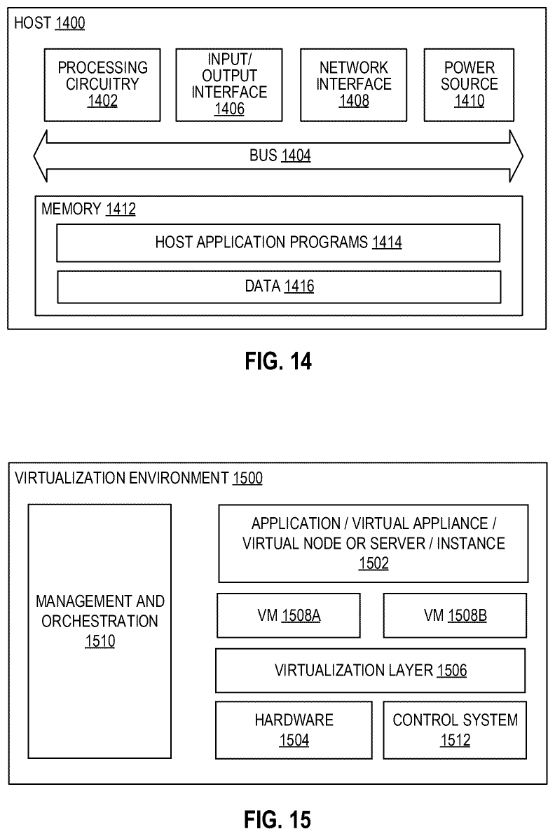

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1500 includes components defined by the O-RAN Alliance, such as an O-Cloud environment orchestrated by a Service Management and Orchestration Framework via an O-2 interface.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve data rate, latency, power consumption and thereby provide benefits such as reduced user waiting time, relaxed restriction on file size, improved content resolution, better responsiveness, and extended battery lifetime.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The wireless device 130 embodiments relate to FIG. 3, any of FIGS. 5-6, FIG. 7 and FIGS. 11-16.

The wireless device 130 may comprise an arrangement as shown in FIG. 7 or in FIG. 16.

The network node 110 embodiments relate to FIG. 4, any of FIGS. 5-6, FIG. 8 and

FIGS. 11-16.

The network node 110 may comprise an arrangement as shown in FIG. 8 or in FIG. 16.

### FURTHER NUMBERED EMBODIMENTS

1. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform one or more of the actions described herein as performed by the network node 110.
2. The host of the previous embodiment, wherein:
the processing circuitry of the host is configured to execute a host application that provides the user data; and
the UE comprises processing circuitry configured to execute a client application associated with the host application to receive the transmission of user data from the host.
3. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs one or more of the actions described herein as performed by the network node 110.
4. The method of the previous embodiment, further comprising, at the network node, transmitting the user data provided by the host for the UE.
5. The method of any of the previous 2 embodiments, wherein the user data is provided at the host by executing a host application that interacts with a client application executing on the UE, the client application being associated with the host application.
6. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform one or more of the actions described herein as performed by the network node 110.
7. The communication system of the previous embodiment, further comprising:
the network node; and/or
the user equipment.
8. The communication system of the previous 2 embodiments, wherein:
the processing circuitry of the host is configured to execute a host application, thereby providing the user data; and
the host application is configured to interact with a client application executing on the UE, the client application being associated with the host application.
9. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform one or more of the actions described herein as performed by the network node 110.
10. The host of the previous 2 embodiments, wherein:
the processing circuitry of the host is configured to execute a host application, thereby providing the user data; and
the host application is configured to interact with a client application executing on the UE, the client application being associated with the host application.
11. The host of the any of the previous 2 embodiments, wherein the initiating receipt of the user data comprises requesting the user data.
12. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs one or more of the actions described herein as performed by the network node 110.
13. The method of the previous embodiment, further comprising at the network node, transmitting the received user data to the host.
14. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform one or more of the actions described herein as performed by the wireless device 130.
15. The host of the previous embodiment, wherein the cellular network further includes a network node configured to communicate with the UE to transmit the user data to the UE from the host.
16. The host of the previous 2 embodiments, wherein:
the processing circuitry of the host is configured to execute a host application, thereby providing the user data; and
the host application is configured to interact with a client application executing on the UE, the client application being associated with the host application.
17. A method implemented by a host operating in a communication system that further includes a network node and a user equipment (UE), the method comprising:
providing user data for the UE; and
initiating a transmission carrying the user data to the UE via a cellular network comprising the network node, wherein the UE performs one or more of the actions described herein as performed by the wireless device 130.
18. The method of the previous embodiment, further comprising:
at the host, executing a host application associated with a client application executing on the UE to receive the user data from the UE.
19. The method of the previous embodiment, further comprising:
at the host, transmitting input data to the client application executing on the UE, the input data being provided by executing the host application,
wherein the user data is provided by the client application in response to the input data from the host application.
20. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform one or more of the actions described herein as performed by the wireless device 130.
21. The host of the previous embodiment, wherein the cellular network further includes a network node configured to communicate with the UE to transmit the user data from the UE to the host.
22. The host of the previous 2 embodiments, wherein:
the processing circuitry of the host is configured to execute a host application, thereby providing the user data; and
the host application is configured to interact with a client application executing on the UE, the client application being associated with the host application.
23. A method implemented by a host configured to operate in a communication system that further includes a network node and a user equipment (UE), the method comprising:
at the host, receiving user data transmitted to the host via the network node by the UE, wherein the UE performs one or more of the actions described herein as performed by the wireless device 130.
24. The method of the previous embodiment, further comprising:
at the host, executing a host application associated with a client application executing on the UE to receive the user data from the UE.
25. The method of the previous embodiments, further comprising:
at the host, transmitting input data to the client application executing on the UE, the input data being provided by executing the host application,
wherein the user data is provided by the client application in response to the input data from the host application.

### REFERENCES

[1] Erik Dahlman; Stefan Parkvall, Johan Sköld (2020) “5G NR: The Next Generation Wireless Access Technology”, Academic Press.

1. A method performed by a wireless device, the method being for handling information, the wireless device operating in a wireless communications network, and the method comprising:
sending information to a network node operating in the wireless communications network, the sending of the information being with a first priority, the first priority being a) based on a delay in the transmission of the information, and b) independent of a second priority assigned to an identity of a logical channel used for the sending of the information and a group of the logical channel.

2. The method according to claim 1, wherein the first priority is a priority applied in a first order, and wherein, with the proviso a same delay in the transmission applies to a plurality of sets of information, each of the sets in the plurality having at least one of: different identities of logical channel, and different groups of logical channel, the second priority is applied in a subsequent order, the second priority being based, within each group having a same delay in transmission, on a respective priority assigned to the at least one of different identities of logical channel, and different groups of logical channel.

3. The method according to claim 1, further comprising:
obtaining a first indication of the first priority, and wherein the sending is performed based on the obtained first indication, and
determining the first priority based on the obtained first indication, wherein the sending is performed based on the determined first priority.

4. The method according to claim 3, wherein the first indication is at least one of:
obtained from the network node,
indicating one or more delay buckets,
indicating a respective index of the one or more delay buckets,
indicating one or more packet delay budgets, PDB,
indicating one or more grants the first indication is to be applied to,
a priority parameter overriding a second priority assigned to the identity of the logical channel used for the sending of the information and a group of the logical channel, and
a lchPriority indicator.

5. The method according to claim 4, wherein a plurality of delay buckets is indicated in the first indication, and wherein the first priority is based on a respective delay of the plurality of delay buckets.

6. The method according to claim 1, wherein the sending is on a set of time-frequency resources having insufficient capacity to transmit all information in a buffer of the wireless device, and wherein the sending is at least one of:
based on one or more conditions,
based on one or more periodic grants, regions or locations of time-frequency resources, and
multiplexing a plurality of logical channels of different priorities in the same set of time-frequency resources.

7. The method according to claim 6, wherein at least one of:
the delay is a remaining latency budget,
the one or more conditions are based on a priority bit rate value,
the one or more conditions are based on the first priority being enabled, and
the time-frequency resources are a transport block.

8. The method according to claim 1 wherein at least one of:
the information comprises at least one of: data and one or more packets,
the wireless communications network supports extended reality, XR, and
the wireless communications network supports XR in Fifth Generation, 5G.

9. A method performed by network node, the method being for handling information, the network node operating in a wireless communications network, and the method comprising:
receiving information from a wireless device operating in the wireless communications network, the receiving of the information being with a first priority, the first priority being a) based on a delay in the transmission of the information, and b) independent of a second priority assigned to an identity of a logical channel used for the receiving of the information and a group of the logical channel.

10. The method according to claim 9, wherein the first priority is a priority applied by the wireless device in a first order, and wherein, with the proviso a same delay in the transmission applies to a plurality of sets of information, each of the sets in the plurality having at least one of: different identities of logical channel, and different groups of logical channel, the second priority is applied in a subsequent order, the second priority being based, within each group having a same delay in transmission, on a respective priority assigned to the at least one of different identities of logical channel, and different groups of logical channel.

11. The method according to claim 9, further comprising:
sending a first indication of the first priority to the wireless device, and wherein the receiving is performed based on the sent first indication.

12. The method according to claim 11, wherein the first indication is at least one of:
indicating one or more delay buckets,
indicating a respective index of the one or more delay buckets,
indicating one or more packet delay buckets, PBD,
indicating one or more grants the first indication is to be applied to,
a priority parameter overriding the second priority assigned to the identity of a logical channel used for the sending of the information and a group of the logical channel, and
a lchPriority indicator.

13. The method according to claim 12, wherein a plurality of delay buckets is indicated in the first indication, and wherein the first priority is based on a respective delay of the plurality of delay buckets.

14. The method according to claim 9, wherein the receiving is on a set of time-frequency resources having insufficient capacity to transmit all information in a buffer of the wireless device, and wherein the receiving is at least one of:
based on one or more conditions,
based on one or more periodic grants, regions or locations of time-frequency resources, and
multiplexing a plurality of logical channels of different priorities in the same set of time-frequency resources.

15. The method according to claim 14, wherein at least one of:
the delay is a remaining latency budget,
the one or more conditions are based on a priority bit rate value,
the one or more conditions are based the first priority being enabled, and
the time-frequency resources are a transport block.

16. The method according to claim 9,
wherein at least one of:
the information comprises at least one of: data and one or more packets,
the wireless communications network supports extended reality, XR, and
the wireless communications network supports XR in Fifth Generation, 5G.

17. A wireless device for handling information, the wireless device being configured to operate in a wireless communications network, and the wireless device being further configured to:
send information to a network node configured to operate in the wireless communications network, the sending of the information being configured to be with a first priority, the first priority being configured to be a) based on a delay in the transmission of the information, and b) independent of a second priority configured to be assigned to an identity of a logical channel configured to be used for the sending of the information and a group of the logical channel.

18. The wireless device according to claim 17, wherein the first priority is configured to be a priority configured to be applied in a first order, and wherein, with the proviso a same delay in the transmission is configured to apply to a plurality of sets of information, each of the sets in the plurality having at least one of: different identities of logical channel, and different groups of logical channel, the second priority is configured to be applied in a subsequent order, the second priority being configured to be based, within each group having a same delay in transmission, on a respective priority configured to be assigned to the at least one of different identities of logical channel, and different groups of logical channel.

19. The wireless device according to claim 17, being further configured to:
obtain a first indication of the first priority, and wherein the sending is configured to be performed based on the first indication configured to be obtained, and
determine the first priority based on the first indication configured to be obtained, wherein the sending is configured to be performed based on the first priority configured to be determined.

20.-24. (canceled)

25. A network node, for handling information, the network node being configured to operate in a wireless communications network, and the network node being further configured to:
receive information from a wireless device configured to operate in the wireless communications network, the receiving of the information being with configured to be a first priority, the first priority being configured to be a) based on a delay in the transmission of the information, and b) independent of a second priority configured to be assigned to an identity of a logical channel configured to be used for the receiving of the information and a group of the logical channel.

26.-32. (canceled)
